(19) United States
(12) Patent Application Publication
(10) Pub. No.: US 2012/0072650 A1
(43) Pub. Date: Mar. 22, 2012

(54) MEMORY SYSTEM AND DRAM CONTROLLER

(75) Inventors: Tatsuhiro SUZUMURA, Kanagawa (JP); Kunihiko Yahagi, Kanagawa (JP)

(73) Assignee: KABUSHIKI KAISHA TOSHIBA, Tokyo (JP)

(21) Appl. No.: 13/238,357

(22) Filed: Sep. 21, 2011

(30) Foreign Application Priority Data
Sep. 22, 2010 (JP) 2010-212705

(51) Int. Cl. G06F 12/00

(52) U.S. Cl. 711/103; 711/105; 711/E12.008

(57) ABSTRACT

According to one embodiment, a DRAM controller includes a clock generating and switching unit for supplying a first clock to a DRAM in a normal operation and generating a second clock having a lower speed than the first clock and supplying the generated second clock to the DRAM in an initialization processing, and a DRAM access circuit having a DLL circuit for regulating a fetch timing of data output from the DRAM based on the first clock, and fetching, in a fetch timing regulated by the DLL circuit, data output from the DRAM in a timing based on the second clock in relation to the initialization processing and the transfer data output from the DRAM in a timing based on the first clock in the initialization processing and the normal processing, respectively.

### CROSS-REFERENCE TO RELATED APPLICATIONS

This application is based upon and claims the benefit of priority from Japanese Patent Application No. 2010-212705, filed on Sep. 22, 2010; the entire contents of which are incorporated herein by reference.

### FIELD

Embodiments described herein relate generally to a memory system and a DRAM controller.

### BACKGROUND

As an external storage device to be used in a computer system, attention is paid to an SSD (Solid State Drive) provided with a flash memory (a flash EEPROM) to be a nonvolatile memory. Compared with a magnetic disk device, the flash memory has an advantage of a higher speed, a smaller weight or the like. The SSD includes a plurality of flash memory chips, a controller to carry out a read/write control of a nonvolatile memory according to requests from a host device, a volatile buffer memory for carrying out a data transfer between the nonvolatile memory and the host device, and the like.

In recent years, referring to a DRAM (Dynamic Random Access Memory), there is proposed a new standard referred to as an LPDDR 2 (Low Power Double-Data-Rate 2). When a DRAM conforming to the LPDDR2 standard is applied to a buffer memory of an SSD, it is possible to further reduce power consumption of the SSD. According to the LPDDR2 standard, it is defined to carry out an initialization processing of the DRAM in a clock from 10 MHz to 55 MHz.

### BRIEF DESCRIPTION OF THE DRAWINGS

FIG. 1 is a diagram for explaining a role of a DLL circuit;

FIG. 2 is a diagram for explaining an initialization processing based on the LPDDR2 standard;

FIG. 3 is a block diagram showing an example of a structure of an SSD as a memory system according to an embodiment of the invention;

FIG. 4 is a diagram for explaining a structure of a DRAM controller;

FIG. 5 is a diagram for explaining a functional structure of a speed control circuit;

FIG. 6 is a circuit diagram showing a clock selecting circuit;

FIG. 7 is a timing chart for explaining timings of various signals in the initialization processing; and

FIG. 8 is a flowchart for explaining an operation of a DRAM controller in the initialization processing.

### DETAILED DESCRIPTION

In general, according to one embodiment, a memory system includes a nonvolatile memory, a DRAM for temporarily storing transfer data between the nonvolatile memory and a host device, and a DRAM controller for executing an initialization processing of the DRAM and executing an input/output of the transfer data to/from the DRAM in a normal operation after the initialization processing. The DRAM controller includes a clock generating and switching unit for supplying a first clock to the DRAM in the normal operation and generating a second clock having a lower speed than the first clock and supplying the generated second clock to the DRAM in the initialization processing, and a DRAM access circuit having a DLL circuit for regulating a fetch timing of data output from the DRAM based on the first clock, and fetching, in a fetch timing regulated by the DLL circuit, the data output from the DRAM in a timing based on the second clock in relation to the initialization processing and the transfer data output from the DRAM in a timing based on the first clock in the initialization processing and the normal processing, respectively.

Exemplary embodiments of a memory system and a DRAM controller will be explained below in detail with reference to the accompanying drawings. The present invention is not limited to the following embodiments.

According to a DDR method including the LPDDR2 standard, data are fetched at both rising and falling edges of a data strobe signal (a DQS signal) generated based on a clock to implement a double transfer speed (a double data rate) as compared with the case in which data are fetched through only the rising edge of the DQS signal. A DRAM controller for controlling a DRAM includes a DLL (Delay Locked Loop) circuit for controlling a data fetch timing with high precision with respect to the rising and falling edges of the DQS signal.

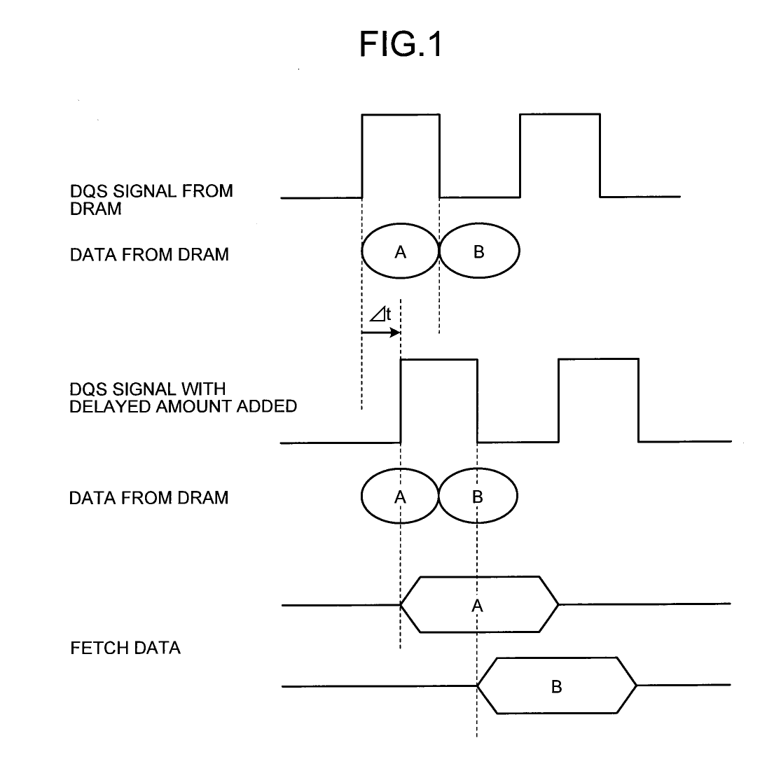

FIG. 1 is a diagram for explaining a role of the DLL circuit. As shown, read data are transferred as a signal having a double data rate which is synchronous with both edges of the DQS signal from the DRAM to the DRAM controller. The DRAM generates the DQS signal by using a driving clock of the DRAM itself. In the DRAM controller, the DLL circuit delays the DQS signal by only a predetermined time (At in the drawing) and generates a read timing signal. The delay amount At of the DQS signal is regulated by using a shift amount. The DRAM controller fetches data in respective timings of the rising edge and the falling edge of the timing signal to convert read data from a signal having a double data rate into a signal having a single data rate of two systems. The signal converted into the single data rate is respectively transferred to a module to be a reading destination.

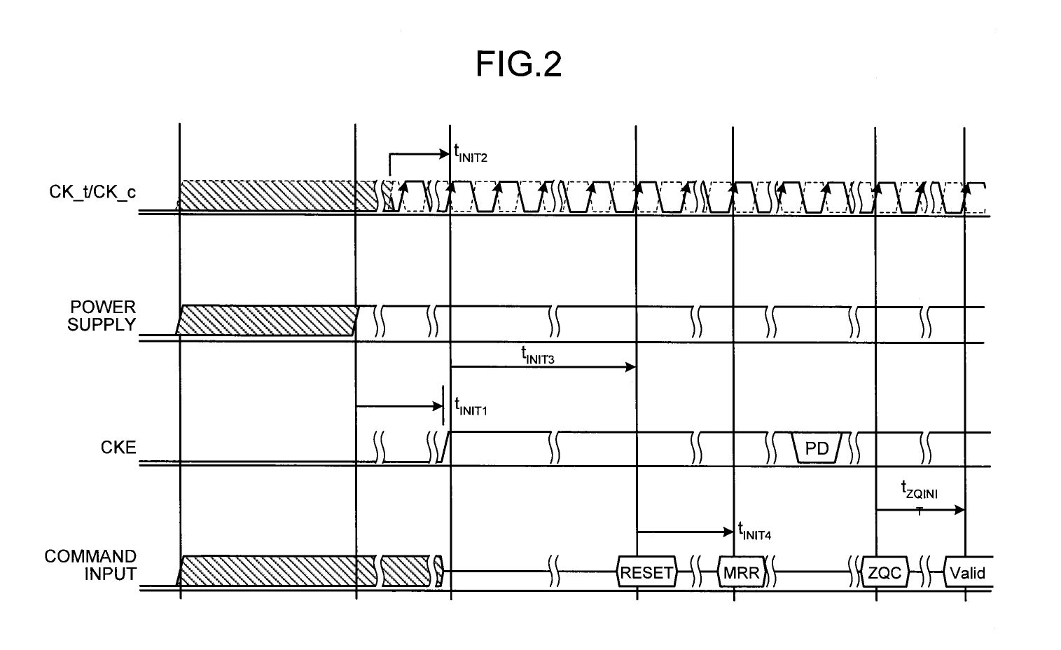

FIG. 2 is a diagram for explaining the initialization processing based on the LPDDR2 standard. As shown, the initialization processing includes a reset processing for transmitting a RESET command to the DRAM to reset the DRAM, a mode register read (MRR) processing for issuing a mode register read (MRR) command to read a response to the RESET command (output data to be subjected to the initialization processing) from a DAI (Device Auto Initialization) bit contained in a mode register (MR), and a calibration processing for issuing a ZQC (ZQ Calibration) command to regulate an output driver possessed by the DRAM. In the MRR processing, a content of the DAI bit is transmitted to the DRAM controller together with the DQS signal, and the DRAM controller fetches the transmitted content in a timing generated by the DLL circuit. As shown, the DRAM controller drives the DRAM in response to a differential clock having two phases of CK_t and CK_c. Moreover, tINTs 1 to 4 and tZQINT shown in the drawing are standby times for various processings, and respective specific values are defined according to the LPDDR2 standard.

As a technique to be compared with the technique according to the embodiment of the invention, there is proposed a technique for operating the DRAM controller and the DRAM in a clock having a low speed which is defined in the LPDDR2 in the initialization processing (a technique according to a comparative example). However, a DLL circuit which is operated in a high speed clock, for example, several hundreds MHz is employed in such a manner that a high speed data transfer can be executed. In the DLL circuit which is operated in the high speed clock, an operation may become unstable in a low speed clock such as a frequency in the initialization processing defined in the LPDDR2 standard. As a result, the content of the mode register cannot be fetched accurately in some cases. Moreover, the DLL circuit has a practical problem in that a long time is taken until a frequency is locked again when the frequency is switched.

In the embodiment according to the invention, therefore, the DRAM controller generates a low speed clock defined in the LPDDR2 based on a high speed clock (a reference clock) in a normal operation, and supplies the low speed clock to the DRAM in the initialization processing, while the DRAM controller does not drive the DLL circuit in the low speed clock but the reference clock.

With reference to the accompanying drawings, a memory system and a DRAM controller according to the embodiment of the invention will be described below in detail. The invention is not limited to the embodiment.

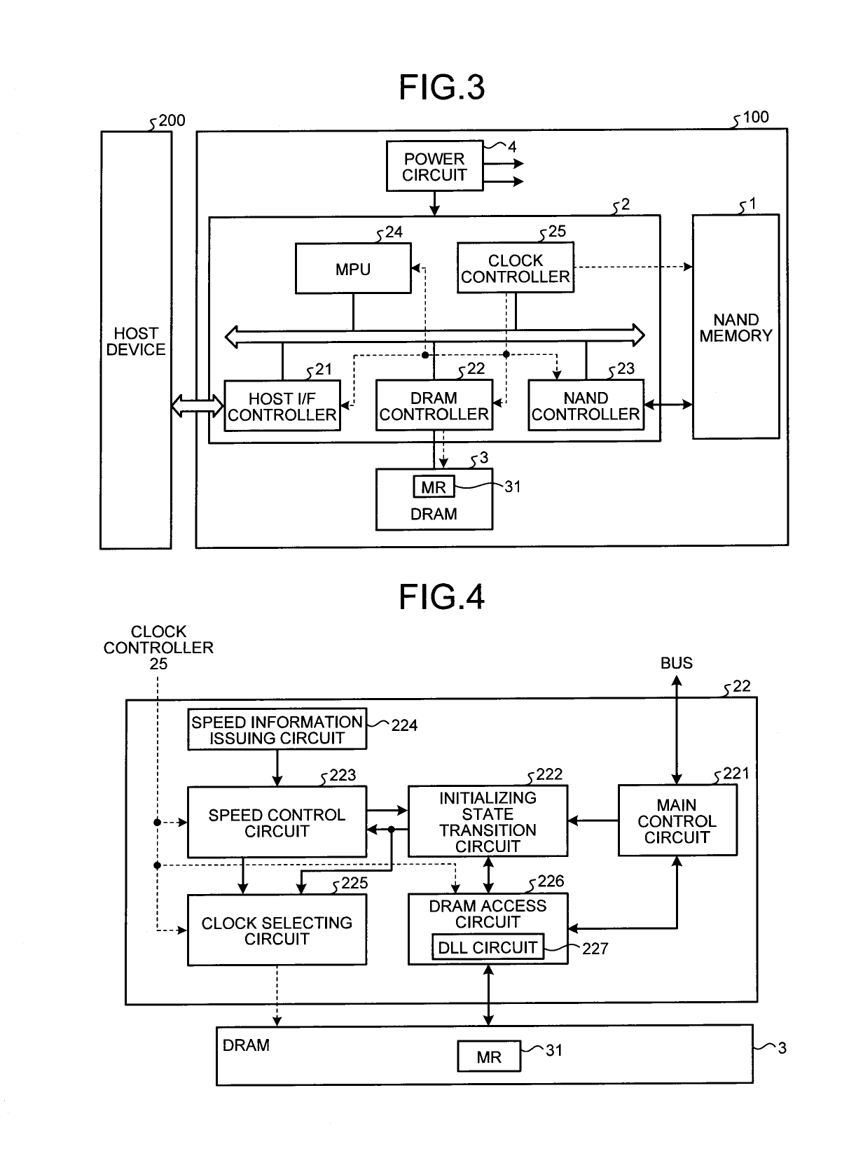

FIG. 3 is a block diagram showing an example of a structure of an SSD serving as the memory system according to the embodiment of the invention. As shown, an SSD 100 is connected to a host device 200 such as a personal computer through a communication interface such as the ATA (Advanced Technology Attachment) standard or the like and functions as an external storage device of the host device 200.

The SSD 100 includes an NAND memory 1, a drive control circuit 2, a DRAM 3 and a power circuit 4.

The NAND memory 1 includes a memory cell array of an NAND type flash memory, and stores data which are demanded by the host device 200 to be written.

The DRAM 3 is a buffer memory for a data transfer between the host device 200 and the NAND memory 1. The data transmitted from the host device 200 are once stored in the DRAM 3 under control of the drive control circuit 2, and are then read from the DRAM 3 and are written to the NAND memory 1. There is employed the DRAM 3 conforming to the LPDDR2 standard, and the DRAM 3 includes a mode register (MR) 31 which is subjected to read/write in the initialization processing. The DRAM 3 includes peripheral circuits such as a column decoder, a row decoder and a sense amplifier, which are not shown. Moreover, the DRAM 3 can also be used for other uses, for example, a storage area of various management data, a work area of an MPU 24 which will be described below and the like in addition to a temporal storage area of transferred data.

A power circuit 4 generates an internal power for driving the drive control circuit 2 and the NAND memory 1, and supplies the generated internal power to each of the NAND memory 1, the drive control circuit 2 and the DRAM 3.

The drive control circuit 2 further includes a host interface controller (a host I/F controller) 21 for executing a control of a communication interface together with the host device 200 and a control of a data transfer between the host device 200 and the DRAM 3, a DRAM controller 22 for controlling read/write of data from/to the DRAM 3, an NAND controller 23 for executing a control of a data transfer between the NAND memory 1 and the DRAM 3, an MPU 24 for executing a control of the whole drive control circuit 2 based on firmware, and a clock controller 25.

The clock controller 25 is constituted by a PLL (Phase locked loop), for example. A clock (hereinafter referred to as a reference clock) generated by the clock controller 25 is supplied to the host I/F controller 21, the DRAM controller 22, the NAND controller 23, the MPU 24, and the NAND memory 1. Moreover, the reference clock is input to the DRAM 3 through the DRAM controller 22.

The DRAM controller 22 executes an initialization processing of the DRAM 3 when the SSD 100 is powered on in addition to the control of the read/write of data from/to the DRAM 3. As described above, according to the LPDDR2 standard, it is defined to execute the initialization processing in a clock from 10 MHz to 55 MHz. According to the embodiment of the invention, the DRAM controller 22 generates a clock having a frequency within a range defined in the LPDDR2 standard based on the reference clock when the initialization processing is to be executed.

FIG. 4 is a diagram for explaining a further detailed structure of the DRAM controller 22. As shown, the DRAM controller 22 includes a main control circuit 221, an initializing state transition circuit 222, a speed control circuit 223, a speed information issuing circuit 224, a clock selecting circuit 225, and a DRAM access circuit 226. Although a reference clock is input from the clock controller 25 to only the clock selecting circuit 225 and the DRAM access circuit 226 in FIG. 4, the reference clock is also supplied to each of the main control circuit 221, the initializing state transition circuit 222, the speed control circuit 223 and the speed information issuing circuit 224.

The DRAM access circuit 226 latches and fetches write data transmitted from a module to be a writing source, and transfers the write data thus fetched to the DRAM 3. Moreover, the DRAM access circuit 226 latches and fetches read data transmitted from the DRAM 3, and transfers the read data thus fetched to a module to be a reading source.

The DRAM access circuit 226 includes a DLL circuit 227 for controlling a timing for fetching the read data transferred from the DRAM 3. The DLL circuit 227 is input a delay amount from the main control circuit 221 and delays a DQS signal sent from the DRAM 3 by the delay amount thus input, thereby regulates a timing for fetching the read data. The DRAM access circuit 226 fetches the read data in the timing regulated by the DLL circuit 227.

The main control circuit 221 controls the DRAM access circuit 226 based on a control signal received through a bus of the drive control circuit 2, thereby executes an access to the DRAM 3 in a normal operation. Moreover, the main control circuit 221 inputs the delay amount to the DLL circuit 227. Furthermore, the main control circuit 221 issues an initialization processing indicating signal to the initializing state transition circuit 222 when the SSD is started.

The initializing state transition circuit 222 is a state machine for carrying out a sequence control according to the initialization processing of the DRAM 3. Upon receipt of the initialization processing indicating signal, the initializing state transition circuit 222 issues a low speed operation indicating signal to the speed control circuit 223 and the clock selecting circuit 225. Then, the initializing state transition circuit 222 carries out an internal state transition based on a state updating signal generated by the speed control circuit 223. A state to which the initializing state transition circuit 222 makes a transition includes a state for standing by for a predetermined time (tINTs 1 to 4, tZQINT or the like), a state for issuing RESET, a state for executing MRR and a state for issuing ZQC. The initializing state transition circuit 222 issues an RESET command, an MRR command and a ZQC command through the DRAM access circuit 226 and reads the MR 31.

The speed information issuing circuit 224 issues a dividing value specifying signal (speed information) for specifying a dividing ratio (a dividing value) in the initialization processing. The speed information issuing circuit 224 is constituted by a flip flop, a ROM (Read Only Memory) and the like, for example, and the dividing ratio is set when manufactured or the like. The dividing value specifying signal issued by the speed information issuing circuit 224 is sent to the speed control circuit 223. It is sufficient that the speed information has a value capable of specifying a frequency of a low speed clock relatively on the basis of a reference clock, and a dividing rate can also be used in addition to the dividing ratio, for example. Moreover, the dividing ratio is set in such a manner that a frequency obtained by dividing a frequency of the reference clock in the dividing ratio ranges in a frequency in the initialization processing which is defined in the LPDDR2 standard.

The speed control circuit 223 and the clock selecting circuit 225 function as a clock generating and switching unit 220 for generating a low speed clock obtained by dividing the reference clock generated by the clock controller 25 at a dividing ratio specified into the dividing value specifying signal, and switching a clock to be supplied to the DRAM access circuit 226 and the DRAM 3 from the reference clock to the low speed clock upon receipt of the low speed operation indicating signal. Although the speed control circuit 223 and the clock selecting circuit 225 which function as the clock generating and switching unit 220 in cooperation with each other are constituted by independent circuits respectively, the clock generating and switching unit 220 may be constituted by a single circuit. Moreover, the speed control circuit 223 generates a state updating signal to be a pulse signal in an equal cycle to the low speed clock which is generated, and supplies the generated state updating signal to the initializing state transition circuit 222.

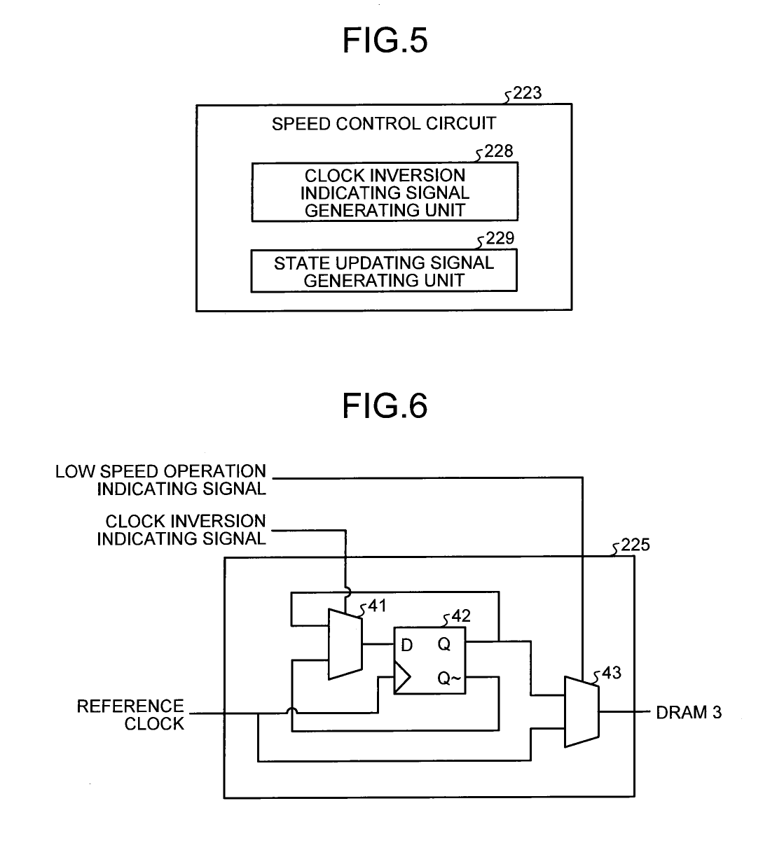

FIG. 5 is a diagram for explaining a functional structure of the speed control circuit 223 and FIG. 6 is a circuit diagram showing the clock selecting circuit 225.

As shown in FIG. 5, the speed control circuit 223 includes a clock inversion indicating signal generating unit 228 and a state updating signal generating unit 229. The clock inversion indicating signal generating unit 228 counts down the reference clock and generates a clock inversion indicating signal constituted by a pulse in a cycle which is 2ⁿ⁻¹ (n is an integer of one or more) times as great as the reference clock when the dividing ratio specified by the dividing value specifying signal is 2ⁿ. The state updating signal generating unit 229 counts down the reference clock and generates a state updating signal constituted by a pulse in a cycle which is 2ⁿ times as great as the reference clock. It is assumed that each of the pulses of the clock inversion indicating signal and the state updating signal has a pulse width corresponding to one cycle of the reference clock.

As shown in FIG. 6, the clock selecting circuit 225 includes a selector 41, a D flip flop (D-FF) 42 and a selector 43. A Q output of the D-FF 42 and a /Q (“/” attached before “Q” implies an inversion) output are input to an input port of the selector 41, and one of the two inputs is selected and output by using the clock inversion indicating signal as a selecting signal. An output of the selector 41 is input to a D input port of the D-FF 42, and the reference clock is input to a clock input of the D-FF 42. By the connection, when the clock inversion indicating signal is input, a Q output port of the D-FF 42 outputs a low speed clock having a frequency which is equal to a frequency obtained by dividing the frequency of the reference clock by 1/2ⁿ. The reference clock and the low speed clock output from the Q output port of the D-FF 42 are input to the input port of the selector 43, and the low speed operation indicating signal is set to be the selecting signal to select and output one of the two input signals. The reference clock or the low speed clock which is output from the clock selecting circuit 225 is supplied to the DRAM 3.

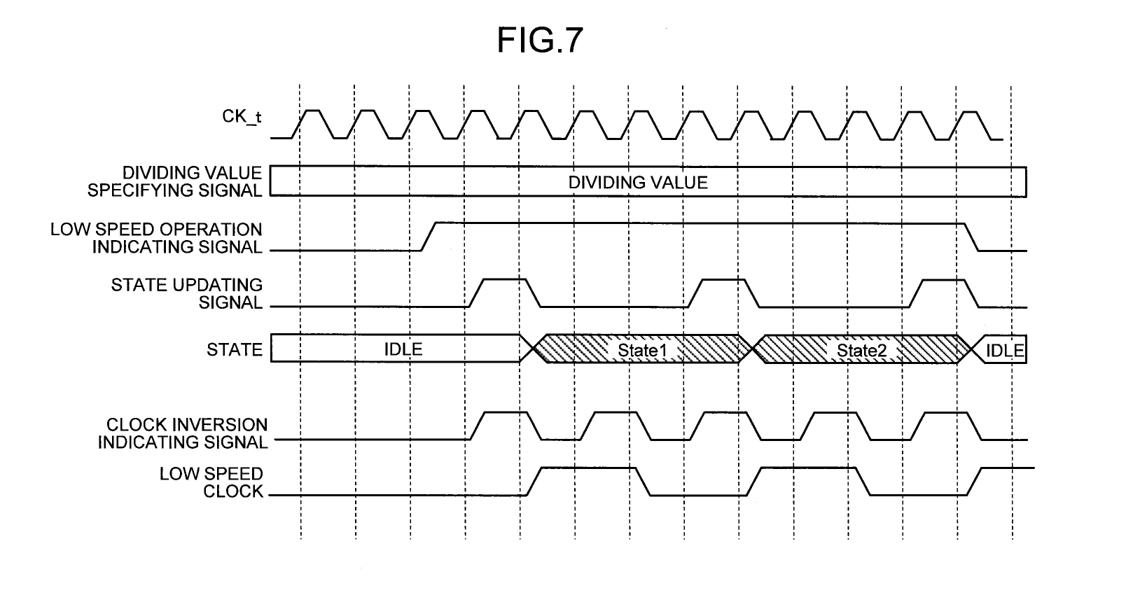

FIG. 7 is a timing chart for explaining timings of various signals in the initialization processing. FIG. 7 shows, from an uppermost stage, the transitions of the reference clock (only CK_t is illustrated), the dividing value specifying signal, the low speed operation indicating signal, the state updating signal, the state, the clock inversion indicating signal, and the low speed clock which is generated, respectively. As shown, a state is inverted in such a timing that an “H” state of the clock inversion indicating signal overlaps with a rising edge of CK_t so that the low speed clock is generated. Moreover, the state updating signal is generated in an equivalent cycle to the low speed clock, and the state makes a transition by setting the state updating signal as a trigger. In FIG. 7, for simplicity, the number of the states related to a serial sequence control is shown to be two.

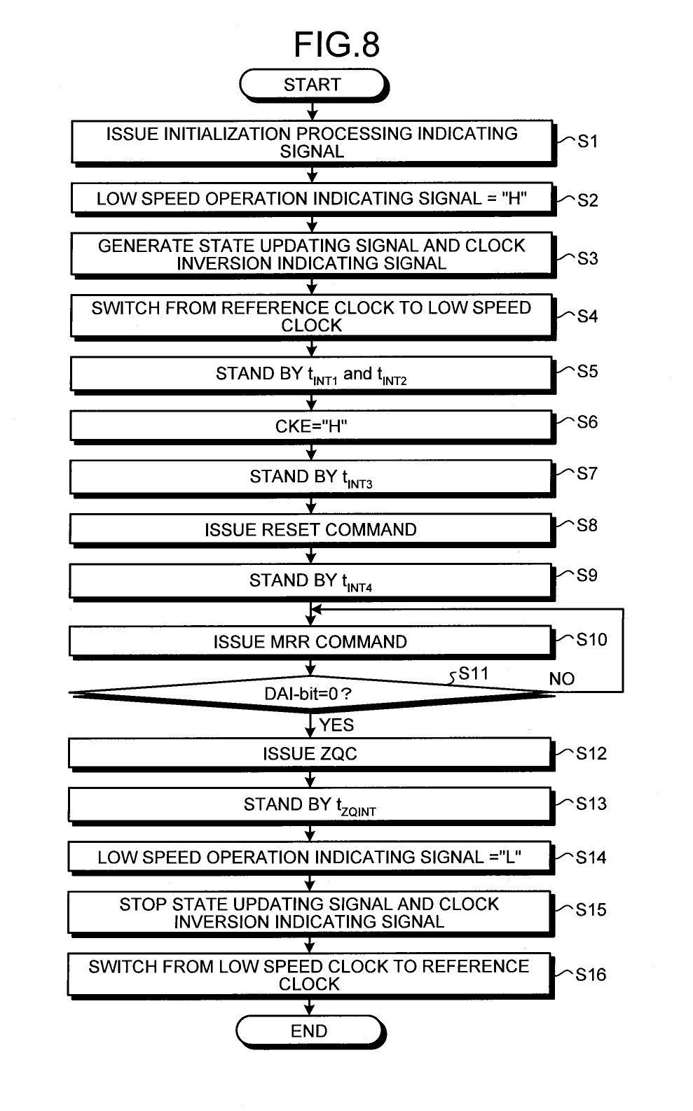

FIG. 8 is a flowchart for explaining the operation of the DRAM controller 22 in the initialization processing. First of all, when a power supply of the SSD 100 is turned on, the main control circuit 221 issues an initialization processing indicating signal (Step S1). Consequently, the initializing state transition circuit 222 issues a low speed operation indicating signal to the speed control circuit 223 and the clock selecting circuit 225 (Step S2). The issuance of the low speed operation indicating signal implies that the low speed operation indicating signal is asserted from “L” to “H”. When the low speed operation indicating signal is asserted, the speed control circuit 223 generates a state updating signal having a dividing ratio which is set to the speed information issuing circuit 24, and furthermore, generates a clock inversion indicating signal for generating a low speed clock (Step S3). When the low speed operation indicating signal is asserted, the clock selecting circuit 225 generates a low speed clock based on the clock inversion indicating signal and a reference clock and a clock to be output is switched from the reference clock to the low speed clock (Step S4). At subsequent steps, the initializing state transition circuit 222 makes a state transition in response to the state updating signal. Moreover, the low speed clock is supplied to the DRAM 3.

The initializing state transition circuit 222 stands by until a time obtained by adding tINT 1 and tINT 2 passes since the power-on (Step S5) and CKE is asserted from “L” to “H” (Step S6). Consequently, the low speed clock is started to be supplied to the DRAM 3. Then, the initializing state transition circuit 222 stands by until tINT 3 passes since a point of time that CKE is asserted (Step S7) and issues an RESET command (Step S8).

The initializing state transition circuit 222 stands by until tINT 4 passes since a point of time that the RESET command is issued (Step S9), and issues an MRR command for reading DAI bit included in the MR 31 (Step S10). The DRAM 3 starts an initialization upon receipt of the RESET command, and writes “0” to DAI bit when the initialization is completed. The initializing state transition circuit 222 decides whether a value of DAI bit read and sent from the MR 31 is “0” or not (Step S11). If the value of DAI bit is not “0” (Step S11, No), the processing proceeds to the Step S10.

If the value of DAI bit is “0” (Step S11, Yes), the initializing state transition circuit 222 issues a ZQC command. Thereafter, the initializing state transition circuit 222 issues the ZQC command (Step S12) and a passage of tZQINT is waited (Step S13), and deasserts the low speed operation indicating signal from “H” to “L” (Step S14).

When the low speed operation indicating signal is deasserted, the speed control circuit 223 stops the generation of the state updating signal and the clock inversion indicating signal (Step S15). When the low speed operation indicating signal is deasserted, the clock selecting circuit 225 switches the clock to be output from the low speed clock to the reference clock (Step S16). After the processing of the Step S16, the DRAM controller 22 ends the initialization processing. Subsequently, the reference clock is supplied to the DRAM 3 so that normal operations of the DRAM controller 22 and the DRAM 3 are started.

As described above, according to the embodiment of the invention, the DRAM controller 22 includes the speed control circuit 223 and the clock selecting circuit 225 (the clock generating and switching unit) for supplying the reference clock to the DRAM 3 in the normal operation and generating the low speed clock and supplying the generated low speed clock to the DRAM 3 in the initialization processing, and the DRAM access circuit 226 having the DLL circuit 227 for regulating the fetch timing of the data output from the DRAM 3 based on the reference clock, and fetching, in the fetch timing regulated by the DLL circuit 227, the content of the MR 31 which is output from the DRAM 3 in the timing based on the low speed clock in the initialization processing and the transfer data between the DRAM 3 and the NAND memory 1 which are output from the DRAM 3 in the timing based on the reference clock in the normal processing, respectively. Therefore, the DLL circuit 227 can be operated in the reference clock while the DRAM 3 is operated in the low speed clock during the initialization processing. Consequently, it is possible to execute the initialization processing of the DRAM 3 in accordance with the LPDDR2 standard while stably operating the DLL circuit 227.

Moreover, the DRAM controller 22 further includes the initializing state transition circuit 222 to be a state machine for executing a sequence control according to the initialization processing, and the state updating signal generating unit 229 for generating the state updating signal to be a pulse signal in an equal cycle to the low speed clock in the initialization processing, and the initializing state transition circuit 222 is constituted to make a state transition by using the state updating signal. Therefore, the DRAM controller 22 can execute an initializing sequence synchronously with the low speed clock in the initialization processing.

In addition, the DRAM controller 22 further includes the speed information issuing circuit 224 for issuing speed information about the low speed clock, and the speed control circuit 223 and the clock selecting circuit 225 (the clock generating and switching unit) is constituted to generate a low speed clock having a corresponding frequency to the speed information issued by the speed information issuing circuit 224. Therefore, it is possible to change the setting of the frequency of the low speed clock by operating the speed information issuing circuit 224.

Although 2 to the n power has been explained as an example of the dividing ratio set to the speed information issuing circuit 224 in the above description, the dividing ratio is not limited thereto.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory;
a DRAM configured to temporarily store transfer data between the nonvolatile memory and a host device; and
a DRAM controller configured to execute an initialization processing of the DRAM and execute an input/output of the transfer data to/from the DRAM in a normal operation after the initialization processing,
the DRAM controller including:
a clock generating and switching unit configured to supply a first clock to the DRAM in the normal operation and generate a second clock having a lower speed than the first clock and supply the generated second clock to the DRAM in the initialization processing; and
a DRAM access circuit having a DLL circuit configured to regulate a fetch timing of data output from the DRAM based on the first clock, and fetch, in a fetch timing regulated by the DLL circuit, the data output from the DRAM in a timing based on the second clock in relation to the initialization processing and the transfer data output from the DRAM in a timing based on the first clock in the initialization processing and the normal processing, respectively.

2. The memory system according to claim 1, wherein the DRAM conforms to the Low Power Double-Data-Rate 2 (LPDDR2) standard, and
a frequency of the second clock is specified in the LPDDR2 standard.

3. The memory system according to claim 2, wherein the output data related to the initialization processing are responsive to a mode register read command.

4. The memory system according to claim 1, further comprising a main control circuit configured to output a delay amount,
the DRAM outputting the output data related to the initialization processing together with a data strobe signal generated based on the second clock, and
the DLL circuit delaying the data strobe signal by the delay amount output from the main control circuit and setting the fetch timing.

5. The memory system according to claim 1, wherein the DRAM controller further includes:
an initialization processing control unit to be a state machine configured to execute a sequence control related to the initialization processing; and
a pulse signal generating unit configured to generate a pulse signal in an equal cycle to the second clock in the initialization processing,
the initialization processing control unit making a state transition by using the pulse signal.

6. The memory system according to claim 1, wherein the DRAM controller further includes a speed information issuing circuit configured to issue speed information about the second clock,
the clock generating and switching unit generating the second clock having a corresponding frequency to the speed information issued by the speed information issuing circuit.

7. The memory system according to claim 6, wherein the speed information is a dividing ratio.

8. The memory system according to claim 6, wherein the speed information is a dividing rate.

9. The memory system according to claim 1, wherein the nonvolatile memory is an NAND type flash memory.

10. A DRAM controller configured to execute an initialization processing of a DRAM and execute an input/output of data to/from the DRAM in a normal operation after the initialization processing, comprising:
a clock generating and switching unit configured to supply a first clock to the DRAM in the normal operation and generate a second clock having a lower speed than the first clock and supply the generated second clock to the DRAM in the initialization processing; and
a DRAM access circuit having a DLL circuit configured to regulate a fetch timing of data output from the DRAM based on the first clock, and fetch, in a fetch timing regulated by the DLL circuit, data output from the DRAM in a timing based on the second clock in relation to the initialization processing and the read data output from the DRAM in a timing based on the first clock in the initialization processing and the normal processing, respectively.

11. The DRAM controller according to claim 10, wherein the DRAM conforms to the Low Power Double-Data-Rate 2 (LPDDR2) standard, and
a frequency of the second clock is specified in the LPDDR2 standard.

12. The DRAM controller according to claim 11, wherein the output data related to the initialization processing are responsive to a mode register read command.

13. The DRAM controller according to claim 10, further comprising a main control circuit configured to output a delay amount,
the DRAM outputting the output data related to the initialization processing together with a data strobe signal generated based on the second clock, and
the DLL circuit delaying the data strobe signal by the delay amount output from the main control circuit and setting the fetch timing.

14. The DRAM controller according to claim 10, further comprising:
an initialization processing control unit to be a state machine configured to execute a sequence control related to the initialization processing; and
a pulse signal generating unit configured to generate a pulse signal in an equal cycle to the second clock in the initialization processing,
the initialization processing control unit making a state transition by using the pulse signal.

15. The DRAM controller according to claim 10, further comprising a speed information issuing circuit configured to issue speed information about the second clock,
the clock generating and switching unit generating the second clock having a corresponding frequency to the speed information issued by the speed information issuing circuit.

16. The DRAM controller according to claim 15, wherein the speed information is a dividing ratio.

17. The DRAM controller according to claim 15, wherein the speed information is a dividing rate.
